(19) United States
(12) Patent Application Publication
(10) Pub. No.: US 2012/0303944 A1
(43) Pub. Date: Nov. 29, 2012

(54) DATA RECOVERING SYSTEM AND METHOD

(75) Inventors: HAI PENG, Shenzhen City (CN); QI-WEI WANG, Shenzhen City (CN)

(73) Assignees: Hon Hai Precision Industry Co., Ltd., Tu-Cheng (TW); Hong Fu Jin Precision Industry (ShenZhen) Co., Ltd, Shenzhen City (CN)

(21) Appl. No.: 13/456,377

(22) Filed: Apr. 26, 2012

(30) Foreign Application Priority Data
May 24, 2011 (CN) 201110135253.6

(51) Int. Cl. G06F 15/177

(52) U.S. Cl. 713/2

(57) ABSTRACT

A basic input output system (BIOS) chip and method recovers specific data when an update of the BIOS chip begins. The BIOS chip obtains a space from a memory of a motherboard and names the space. The BIOS chip saves specific data from a non-volatile random access memory (NVRAM) of the BIOS chip into the space when an update of the BIOS chip begins. The BIOS chip reads the specific data from the space and saves the specific data into the NVRAM of the BIOS chip when the update of the BIOS chip is completed.

### BACKGROUND

1. Technical Field

Embodiments of the present disclosure relate to information processing technology, and particularly to a data recovering system and method.

2. Description of Related Art

A motherboard often includes a basic input output system (BIOS) chip. The BIOS chip may store specific data in a non-volatile random access memory (NVRAM) of the BIOS chip, for example, a universally unique identifier (UUID) of the motherboard or a serial number of components connected to the motherboard. A user can access the specific data from the BIOS chip to check the UUID of the motherboard. For example, the user enters a menu of the BIOS interface to see the specific number when powering up the motherboard. However, at present, the specific data may be deleted or modified when updating the BIOS chip. After the update is finished, the user needs to manually rewrite the specific data into the NVRAM of the BIOS chip. This is tedious and time consuming and thus, there is room for improvement in the art.

### BRIEF DESCRIPTION OF THE DRAWINGS

FIG. 1 is a system view of one embodiment of a data recovering unit.

FIG. 2 is a block diagram of one embodiment of a basic input output system (BIOS) chip included in FIG. 1.

FIG. 3 is a flowchart of one embodiment of a data recovering method.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

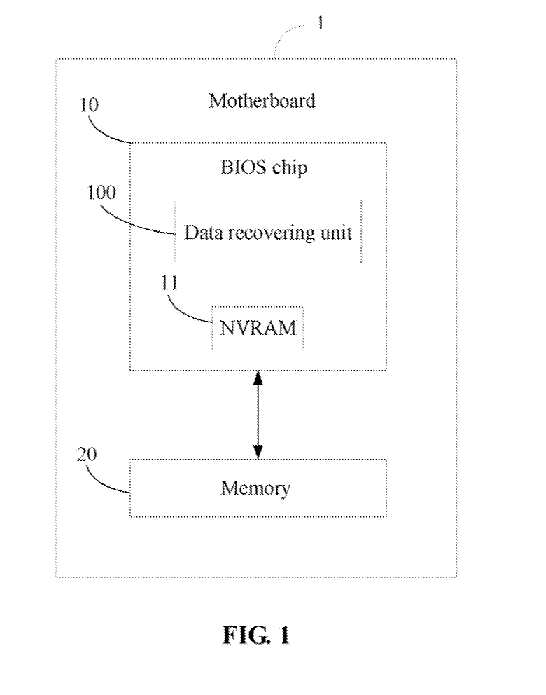

FIG. 1 is a system view of one embodiment of a motherboard 1. The motherboard 1 may include a basic input output system (BIOS) chip 10 and a memory 20. The BIOS chip 10 includes a non-volatile random access memory (NVRAM) 11 and a data recovering unit 100. The data recovering unit 100 may be used to recover specific data which is originally stored in the NVRAM 11. For example, even if the specific data stored in the NVRAM 11 of the BIOS chip 12 is overwritten or corrupted because of an update of the BIOS chip 12, the recovering data unit 100 can recover the specific data from the memory 20. The specific data may be a universally unique identifier (QUID) of the motherboard 1 or a serial number of other components (e.g., a graphical card) connected to the motherboard 1. Further details of the data recovering unit 100 will be described below.

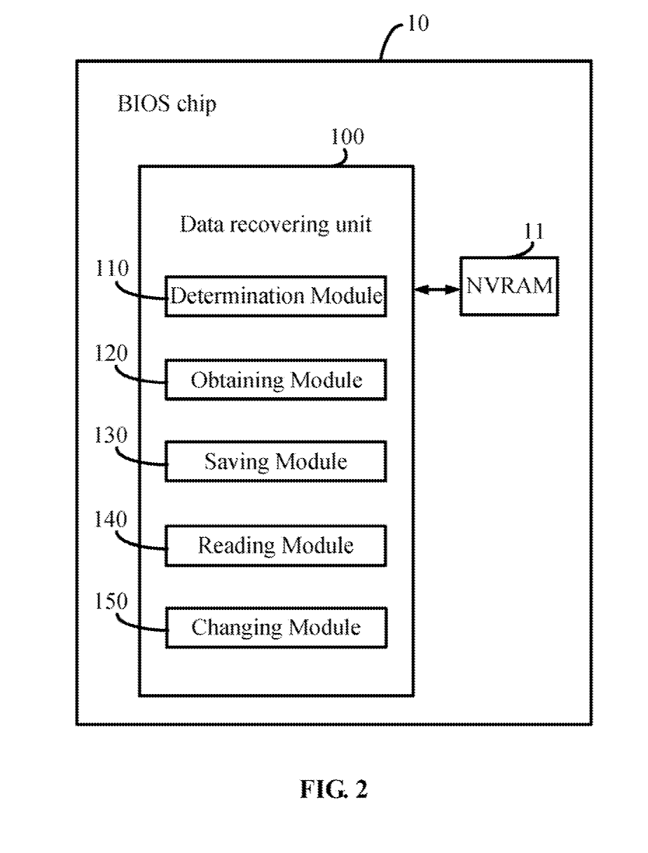

FIG. 2 is a block diagram of one embodiment of the BIOS chip 10 in FIG. 1. In one embodiment, the data recovering unit 100 further includes a determination module 110, an obtaining module 120, a saving module 130, a reading module 140, and a changing module 150. The modules 110-150 may include computerized code in the form of one or more programs that are stored in the NVRAM 11. The computerized code includes instructions that are executed by the BIOS chip 10 to provide functions for modules 110-150.

The determination module 110 determines if the BIOS chip 10 is at a read-write state. In one embodiment, if the BIOS chip 10 is at a low-level voltage (e.g., less than 2.4 V), the BIOS chip 10 is at a read-only state, and the data stored in the BIOS chip 10 can only be read. If the BIOS chip 10 is at a high-level voltage (e.g., greater than 3.5V), and the BIOS chip 10 is at the read-write state. The motherboard 1 can read data from the BIOS chip 10 and write data into the BIOS chip 10 when the BIOS chip 10 is at the read-write state. For example, the motherboard 1 can update the BIOS chip 10 by writing a new version of a BIOS program into the BIOS chip 10. Additionally, the BIOS chip 10 stores an interrupt program (e.g., system management interrupt, SMI). The SMI is used to change voltage of the BIOS chip 10. For example, if the voltage of the BIOS chip 10 is greater than 3.5V, the BIOS chip 10 can invoke the SMI to change the voltage of the BIOS chip 10 to less than 2.4V.

The obtaining module 120 obtains a space from the memory 20 of the motherboard 1 and names the space. In one embodiment, the obtaining module 120 uses a pointer to point to an address of the memory 20, then the space is obtained from the memory 20. Additionally, the obtaining module 120 names the space using a predetermined number. The predetermined number is a globally unique identifier (GUID) number generated by a code application (e.g., GUIDGEN.EXE). Each GUID number is a unique number. The GUID number is burned into the BIOS chip 10 by the code application.

The saving module 130 saves specific data from the NVRAM 11 of the BIOS chip 10 into the space when an update of the BIOS chip begins. In one embodiment, the saving module 130 searches the memory 20 to find the space by the GUID number and saves the specific data into the space.

The reading module 140 reads the specific data from the space and saves the specific data into the NVRAM 11 when the update of the BIOS chip 10 is completed.

The changing module 150 changes the BIOS chip 10 to the read-only state. In one embodiment, the changing module 150 invokes the SMI to change the BIOS chip 10 to a read-only state. For example, the SMI changes the voltage of the BIOS chip 10 from greater than 3.5V to less than 2.4V, then the BIOS chip 10 changes to a read-only state.

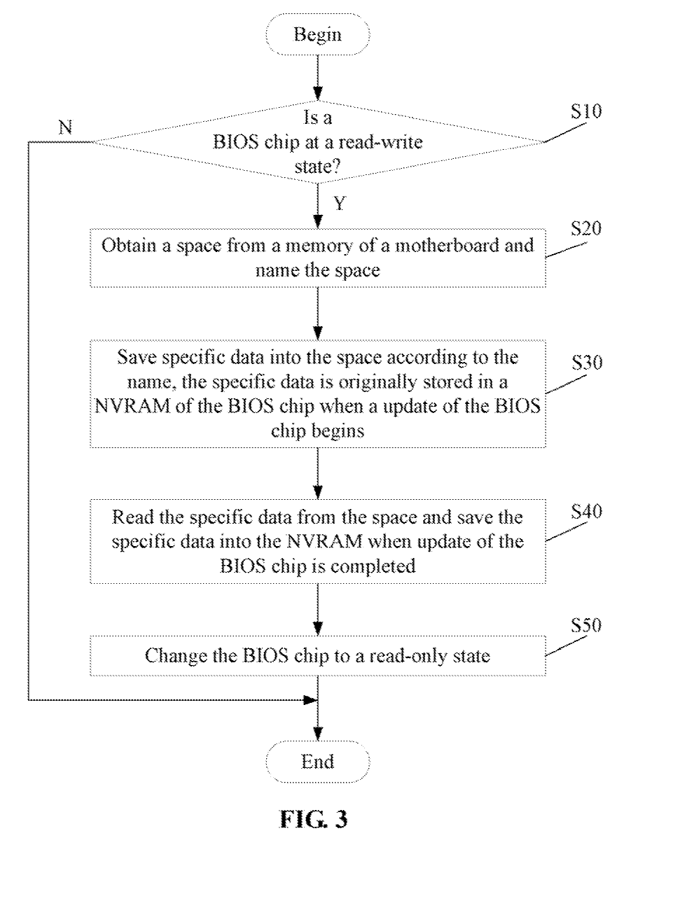

FIG. 3 is a flowchart of one embodiment of a data recovering method. Depending on the embodiment, additional steps may be added, others deleted, and the ordering of the steps may be changed.

In step S10, the determination module 110 determines if the BIOS chip 10 is at a read-write state. For example, if the BIOS chip 10 is at a high-level voltage (greater than 3.5V), and the data stored in the BIOS chip 10 can be read or modified, and a user even can use a tool (e.g., the motherboard 1) to write data into the BIOS chip 10. For example, the motherboard 1 can update the BIOS chip 10 by writing a new version of a BIOS program into the BIOS chip 10. Additionally, if the voltage of the BIOS chip 10 is greater than 3.5V, the motherboard 1 can invoke the SMI to change the voltage of the BIOS chip 10 to less than 2.4V.

In step S20, the obtaining module 120 obtains a space from the memory 20 of the motherboard 1 and names the space. In one embodiment, the space is obtained by a pointer which is pointed to the space of the memory 20. Additionally, the obtaining module 120 names the space using a GUID number.

In step S30, the saving module 130 saves specific data into the space. As mentioned above, the saving module 130 searches the memory 20 to find out the space by the GUID number and saves the specific data into the space.

In step S40, the reading module 140 reads the specific data from the space and saves the specific data into the NVRAM 11 when the update of the BIOS chip 10 is completed.

In step S50, the changing module 150 changes the BIOS chip 10 to a read-only state. For example, the SMI is invoked to change the voltage of the BIOS chip 10 from greater than 3.5V to less than 2.4V, then the BIOS chip 10 changes to a read-only state.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A basic input output system (BIOS) chip of a motherboard, comprising:
a storage system;
at least one processor; and
one or more programs stored in the storage system and being executable by the at least one processor, the one or more programs comprising:
a determination module operable to determine if the BIOS chip is at a read-write state;
an obtaining module operable to obtain a space from a memory of the motherboard and name the space, in response to a determination that the BIOS chip is at the read-write state;
a saving module operable to save specific data from a non-volatile random access memory (NVRAM) of the BIOS chip into the space when an update of the BIOS chip begins;
a reading module operable to read the specific data from the space and save the specific data into the NVRAM when update of the BIOS chip is completed; and
a changing module operable to change the BIOS chip to a read-only state.

2. The BIOS chip of claim 1, wherein the BIOS chip is at a read-write state upon the condition that a voltage of the BIOS chip is less than 2.4V, and the BIOS chip is at a read-only state upon the condition that the voltage of the BIOS chip is greater than 3.5V.

3. The BIOS chip of claim 1, wherein the specific date is a universally unique identifier (QUID) of the motherboard or a serial number of components connected to the motherboard.

4. The BIOS chip of claim 1, wherein the obtaining module uses a pointer to point to an address of the memory to obtain the space from the memory.

5. The BIOS chip of claim 1, wherein the obtaining module names the space using a GUID number.

6. The BIOS chip of claim 1, wherein the changing module invokes an interrupt program to change the BIOS chip to the read-only state, and the interrupt program is system management interrupt (SMI) stored in the BIOS chip.

7. A data recovering method implemented by a basic input output system (BIOS) chip of a motherboard, the method comprising:
obtaining a space from a memory of the motherboard and naming the space, in response to a determination that the BIOS chip is at a read-write state;
saving specific data from a non-volatile random access memory (NVRAM) of the BIOS chip into the space when an update of the BIOS chip begins;
reading the specific data from the space and saving the specific data into the NVRAM of the BIOS chip when the update of the BIOS chip is completed; and
changing the BIOS chip to a read-only state.

8. The method of claim 7, wherein the BIOS chip is at a read-write state upon the condition that a voltage of the BIOS chip is less than 2.4V, and the BIOS chip is at a read-only state upon the condition that the voltage of the BIOS chip is greater than 3.5V.

9. The method of claim 7, wherein the specific date is a universally unique identifier (UUID) of the motherboard or a serial number of components connected to the motherboard.

10. The method of claim 7, wherein the space is obtained by a pointer which is pointed to an address of the memory.

11. The method of claim 7, wherein the space is named after a GUID number.

12. The method of claim 7, wherein an interrupt program is invoked to change the BIOS chip to the read-only state, and the interrupt program is system management interrupt (SMI) stored in the BIOS chip.

13. A non-transitory computer-readable medium having stored thereon instructions that, when executed by a basic input output system (BIOS) chip of a motherboard, the causing the BIOS chip to perform a data recovering method, the method comprising:
obtaining a space from a memory of the motherboard and naming the space, in response to a determination that the BIOS chip is at a read-write state;
saving specific data from a non-volatile random access memory (NVRAM) of the BIOS chip into the space when an update of the BIOS chip begins;
reading the specific data from the space and saving the specific data into the NVRAM of the BIOS chip when the update of the BIOS chip is completed; and
changing the BIOS chip to a read-only state.

14. The medium of claim 13, wherein the BIOS chip is at a read-write state upon the condition that a voltage of the BIOS chip is less than 2.4V, and the BIOS chip is at a read-only state upon the condition that the voltage of the BIOS chip is greater than 3.5V.

15. The medium of claim 13, wherein the specific date is a universally unique identifier (QUID) of the motherboard or a serial number of components connected to the motherboard.

16. The medium of claim 13, wherein the space is obtained by a pointer which is pointed to an address of the memory.

17. The medium of claim 13, wherein the space is named after a GUID number.

18. The medium of claim 13, wherein an interrupt program is invoked to change the BIOS chip to the read-only state, and the interrupt program is system management interrupt (SMI) stored in the BIOS chip.
